(19) United States
(12) Patent Application Publication
(10) Pub. No.: US 2006/0105138 A1
(43) Pub. Date: May 18, 2006

(54) Exercise apparatus towel cover

(76) Inventor: Bryan Christopher Nichols, Loxahatchee, FL (US)

Correspondence Address: Bryan C. Nichols, 2796 Fawn Drive, Loxahatchee, FL, 33470, US

(21) Appl. No.: 10/989,155

(22) Filed: Nov. 16, 2004

(51) Int. Cl. B32B 3/06

(52) U.S. Cl. 428/102

(57) ABSTRACT

A large towel cover assembled with an elastic stretch band sewn into entire outer border for a person using an exercise apparatus. The conforming snug fitting towel acts as a cover over any size or brand exercise equipment upholstery padding thereby providing a perspiration and bacteria barrier. The conforming elastic border prevents the towel from moving or slipping off said equipment upholstery padding. Also, prospective user can use the towel cover to wipe body perspiration from skin.

### CROSS-REFERENCE TO RELATED APPLICATIONS

Not Applicable.

### STATEMENT REGARDING FEDERALLY SPONSORED RESEARCH AND DEVELOPMENT

Not Applicable.

### REFERENCE TO A “MICROFICHE APPENDIX”

Not Applicable.

### BACKGROUND OF INVENTION

Exercise Equipment Towel Cover relates to health and fitness industry and exercisers who use fitness equipment in fitness facilities, home, hotels and the like.

It is often recommended, if not required by health club management that each of its members bring with them a towel when exercising on club's fitness equipment. The intent of the towel is to mitigate sweat from reaching the upholstery of exercise equipment. However, the size of the bath towel normally chosen by exercisers is generally inadequate to cover the entire area of the equipment upholstery. As such, in this manner body sweat is able to reach the upholstery which spawns the second purpose of having a towel available when exercising; which is to wipe off body sweat from the exercise machine.

A second problem with ordinary bath/beach towels used by exercisers is they ordinarily move, slide, or fall off the exercise equipment when the user places their body on them. Exercisers will stretch out a simple bathroom towel over exercise equipment padding with the intent to minimize their body skin from contacting the equipment padding and the towel will fall off the equipment thus exposing their skin to harmful bacteria left from other exercisers. In worse cases the towel falls on the floor requiring the exerciser to stop their workout and pick up their towel off the dirty floor and start over, as a result adding more time to their workout.

Prior art reveals the need for a towel specifically designed for health club patrons, and the alike. For instance, U.S. Des. Pat. No. 385,742 to Bird (1997) discloses an ornamental design for a workout towel detailing artwork in the lower portion; U.S. Pat. No. 5,724,698 to Mondragon (1998) discloses a pocketed towel equipped with an adjustable strap for securing said towel to golf and gym equipment/apparatus; U.S. Pat. No. 5,761,761 to An (1998) discloses a tri-sectioned, multipurpose golf towel comprising two sides of fabric, one side made of an absorbent material such as terry cloth, and the other side made of a more coarse material; U.S. Pat. No. 6,186,155 to Cheek (2001) discloses a function-specific towel having a differentia of portions, allocating one portion to remove perspiration from a user's face/body and allocating another portion to remove perspiration from fitness machines.

While the above mentioned patented items are all towel-related, some are multifunctional, and a handful are merely ornamental. However, none of them introduces a conforming towel as a shield covering the entire exercise equipment padding, protecting the exerciser from harmful bacteria. Nor do they propose as their usefulness to prevent sweat from reaching the exercise machine upholstery.

### BRIEF SUMMARY OF INVENTION

The aforementioned problems with regard to bacteria and sweat contamination between exercisers are mitigated by the present invention.

Accordingly, the present invention provides a comprehensive barrier between a person engaged in an exercise procedure and the exercise equipment upholstery padding. The object of the present invention is to provide a conforming snug fitting cover made of absorbent material that can cover the entire padding upholstery area of an exercise machine and will not slide or fall when and exerciser lies on it.

One of the main components of the towel is its outer border. The outer border is comprised of an elastic stretch band assembled and sewn into the outer edge of the towel whereby providing a conforming snug fit around any type and brand of exercise equipment bench padding/upholstery. The large size of the towel cover invention coupled with the towels conforming border is its unique usefulness.

The inside of the towel cover acts as a shield, protective barrier against other members bacteria sweat. And the outside/top of towel prevents exercisers sweat from reaching exercise equipment machine padding.

In addition, an exerciser can use towel cover to wipe perspiration from body.

### BRIEF DESCRIPTON OF THE DRAWINGS

This invention will be more fully understood from the following detailed description of the preferred embodiment thereof when read in conjunction with the appended drawing wherein:

FIG. 1 is a perspective illustration of my invention (preferred embodiment) taking the form of a towel cover.

FIG. 2 is a side elevation partial view of the preferred embodiment indicated in FIG. 1.

FIG. 3 shows a detailed enlarged fragmentary operational view of the portion 4 indicated in FIG. 1.

### DETAILED DESCRIPTION OF THE INVENTION

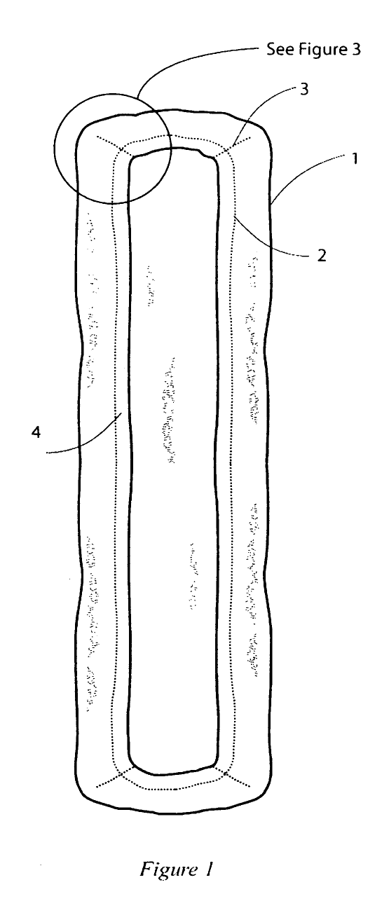

With reference to the drawings, and in particular to FIG. 1 thereof, an Exercise Apparatus Towel Cover invention generally designated by the reference numeral 1 will be described. More specifically, it will be noted that the first embodiment of the invention includes an elongated generally rectangular fabric material portion 1, preferably assembled from a durable cotton material with and elastic stretch band sewn into the outer border of the cotton towel material. In FIG. 1 the object of the invention is to provide an absorbent towel cover which an exerciser engaged on an exercise apparatus can fit over the equipment padding prior to sitting or lying on said equipment. The cover acts as a shield preventing the body's skin from making contact with equipment.

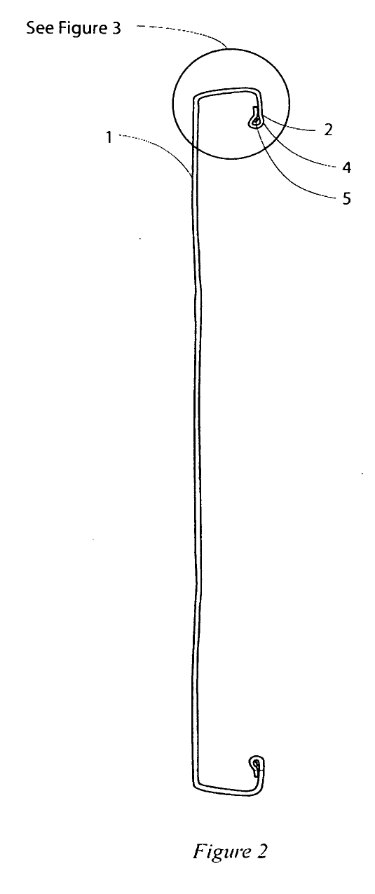

FIG. 2 an alternative embodiment side, partial view of the invention illustrates the conforming edge portion 4, which is constructed by a partial folding over of one end of textile material, through which a seam is created and secured by stitching thread 2 (sewing) to preferred material with elastic stretch band 5 assembled inside seam.

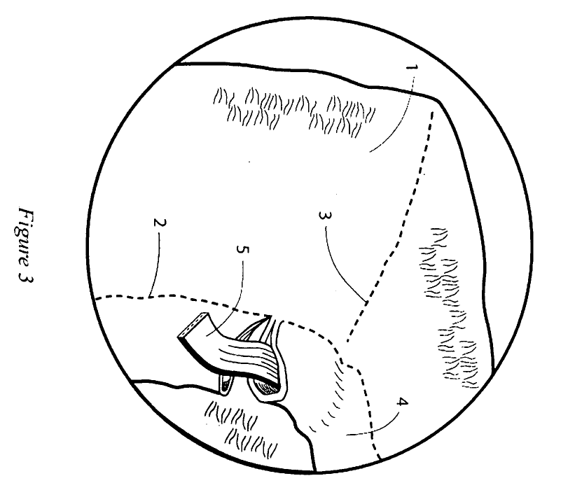

As shown in FIG. 1 a corner is folded and sewn 3 to create an enhanced corner edge at all four corners of rectangular material thus producing a conforming edge which can stretch over an exercise apparatus upholstery padding. FIG. 3 further illustrates the inventions conforming element. The elastic stretch band 5 is assembled inside the inventions folded seam 4 which produces a snug fitting towel able to stretch and conform to any exercise apparatus padding.

While particular embodiments of the present invention have been shown and described, it will be obvious to those skilled in the art that changes and modifications may be made without departing from this invention in its broader aspects. Many other variations are possible. For example, the cloth of the invention in the preferred embodiment can be substituted with any material capable of making an equipment cover such as rubber, leather, plastic, chamois, poly, etc.; the elastic stretch band providing the conforming feature can be replaced by any means of fastening device such as snaps, buttons, velcro, magnets, etc, the cover is not limited to being rectangular in shape, but can take on any number of shapes such as a square, a circle, a triangle, etc.

Therefore, the aim in the appended claims is to cover all such changes and modifications that fall within the true spirit and scope of this invention.

What I claim as my invention is:

1. A conforming, snug fitting exercise apparatus towel cover for use by a person performing an exercise procedure, providing a perspiration and bacteria barrier comprising the combination of:
an elongated length of tufted washable cotton material, affording users a means to prevent human sweat, bacteria and dirt from reaching exercise equipment padding;
said fabric piece having an elastic stretch band sewn into outer border which provides a conforming fit to exercise equipment apparatus thereby preventing towel from moving or slipping off said apparatus.
